(19) United States
(12) Patent Application Publication
(10) Pub. No.: US 2011/0319221 A1
(43) Pub. Date: Dec. 29, 2011

(54) THREE SPEED GEARBOX FROM SINGLE PLANETARY GEARSET

(76) Inventors: James A. O'Brien, II, LaSalle, MI (US); George J. Frank, Deerfield, MI (US)

(21) Appl. No.: 13/170,243

(22) Filed: Jun. 28, 2011

Related U.S. Application Data
(60) Provisional application No. 61/359,515, filed on Jun. 29, 2010.

(51) Int. Cl. F16H 3/44

(52) U.S. Cl. 475/296

(57) ABSTRACT

The present invention is a three forward speed gearbox with reverse from a single planetary gearset. The forward speed ratios include a low gear, one to one, and overdrive. The reverse gear ratio is identical with the low gear. Forward rotation of the output shaft in first gear is accomplished by reversing the direction of the input motor. This is easily achieved from a bi-directional prime mover such as a hydraulic motor or electric motor. Another advantage of using a bi-directional prime mover is that the bi-directional rotation of the input shaft provides forward, reverse and back drive to accumulate energy in an accumulator.

### FIELD OF THE INVENTION

The present invention relates generally to improvements in automatic transmissions for motor vehicles. In particular, the present invention relates to novel improvements to power a transmission in hybrid vehicles.

### BACKGROUND OF THE INVENTION

A planetary gearset has three gear ratios and seven unique combinations of drive direction/ratio, including the direct drive. The gear ratios are determined by the gears in the set and are selected by changing the input element and output element while holding the third element. In practical applications, clutches and bands transmit power or arrest rotation of individual elements in the planetary gear set. But only two forward speeds and a reverse gear are achieved with a single planetary gear set. Automatic transmissions in vehicles traditionally use dual or compound planetary gear sets having one ring gear but with two sun and planetary gear sets each, and using two bands and four clutches to achieve at least three forward ratios ranging from underdrive to overdrive. This limitation arises from the input device, typically an internal combustion engine. Such rotation sources are capable of varying speed and torque, but not rotation direction. The gear ratios and output directions are selected to achieve the desired output torque and rotation based on a unidirectional input source.

### SUMMARY OF THE INVENTION

The present invention is a three forward speed gearbox with reverse from a single planetary gearset. The forward speed ratios include a low gear, one to one, and overdrive. The reverse gear ratio is identical with the low gear. Forward rotation of the output shaft in first gear is accomplished by reversing the direction of the input motor. This is easily achieved from a bi-directional prime mover such as a hydraulic motor or electric motor. Another advantage of using a bi-directional prime mover is that the bi-directional rotation of the input shaft provides forward, reverse and back drive to accumulate energy in an accumulator.

A hydraulic drive motor works efficiently in either direction. Its torque output can be quickly reversed with directional control valves. Both clutch engagement and disengagement for ratio changes and valve sequencing for motor reversal is controlled by either mechanical or electrical means or a combination of controls. By coordinating these events, automatic shift events are possible with three forward ratios and reverse.

In one embodiment of the invention, a planetary gear set for use with a prime mover assembly comprises: a bi-directional prime mover for providing power to a planetary gear set; an input shaft connected at one end to the prime mover and driving a planetary gear set in either direction; the planetary gear set consisting of: one sun gear; one set of planet gears mounted on a carrier for rotating about the sun gear; two bands surrounding the planetary gear set; and two clutch packs for engaging the planetary gear set; an output shaft connected at an opposing end of the planetary gear set and receiving the power from the planetary gear set, wherein the output shaft is driven in one of first gear, reverse gear or backdriving.

The invention also provides methods for driving a planetary gearset by a bid-directional prime mover and providing three gear ratios, reverse and backdrive.

One method comprises the steps of: providing a bi-directional prime mover for powering an input shaft and driving a planetary gear set consisting of: one set of planet gears mounted on a planet carrier and meshing with a sun gear; two clutch packs for engaging the planetary gear set; and two bands for holding the planetary gear set; providing an output shaft for receiving the power from the bi-directional prime mover; engaging a clutch pack to drive the sun gear; holding the planet carrier with a band; and the prime mover rotating the input shaft in either direction to drive the output shaft direction in one of first gear, reverse gear or backdriving.

Another method comprises the steps of: providing a bi-directional prime mover for powering the planetary gear set; providing an input shaft connected to an end of a planetary gear set; providing an output shaft connected to an opposing end of the planetary gear set; the bi-directional prime mover rotating the input shaft in either direction powering the planetary gear set; and the planetary gear set driving an output shaft in either direction and providing three gear ratios and reverse.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 is a rear perspective view of the three speed gearbox of the present invention;

FIG. 2 is a front elevation view of a three speed gearbox along Section 2-2 of FIG. 1;

FIG. 3 is a perspective view of the band assembly of the present invention;

FIG. 4 is a rear perspective view of the rear gear assembly of the invention; and

FIG. 5 is a schematic diagram of the present invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

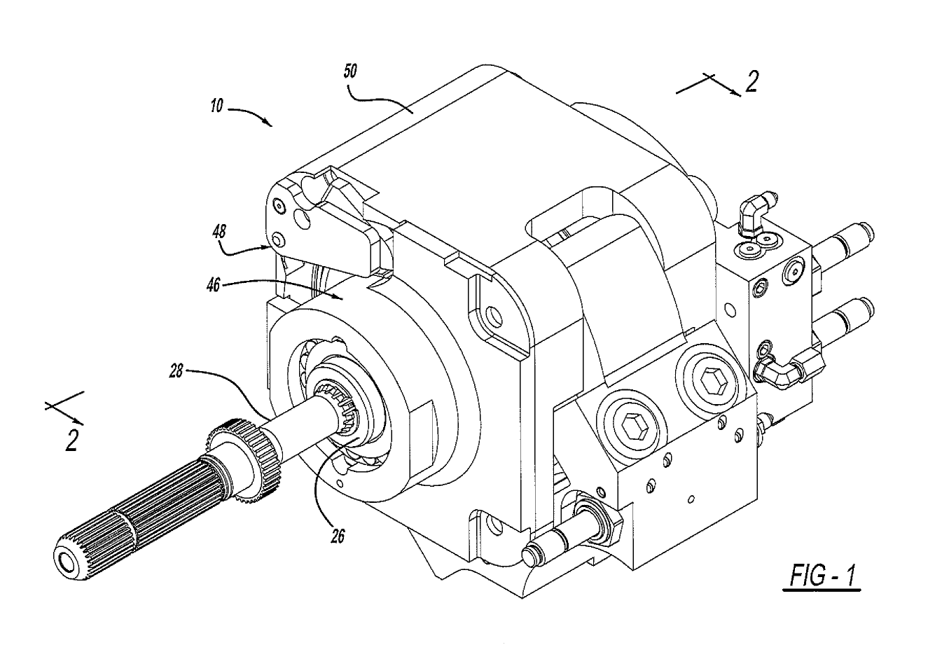

A preferred embodiment of this invention is shown in FIGS. 1, 2 and 5 and includes a planetary gear set 10 for use with a bi-directional prime mover 11. The prime mover 11 may be any bi-directional motor, including but not limited to an electric motor or hydraulic motor. Where the prime mover 11 is a hydraulic motor, an accumulator 50 may be provided to accumulate energy during back drive as described below.

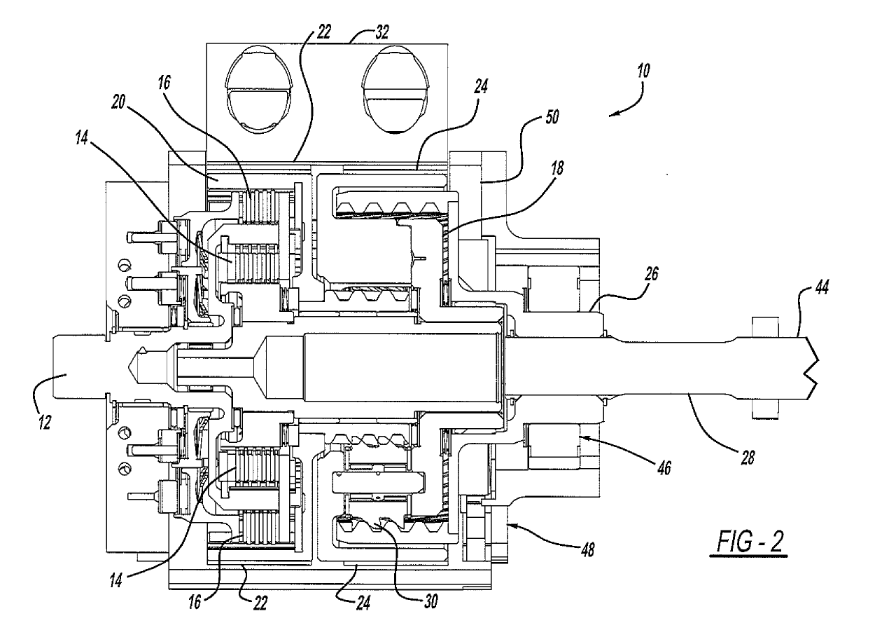

With reference to FIG. 2, the input hub, 12 is splined to the bi-directional prime mover 11. This element transmits torque directly to the gearset 10 from an input source such as bi-directional prime mover 11. The input hub 12 drives two clutch packs, an inner clutch pack 14 and an outer clutch pack 16. When engaged, the inner clutch pack 14 drives the planet carrier 18. The outer clutch pack 16 can engage to drive the sun gear 20. A front band 22 arrests the sun 20. The rear band 24 arrests the planet carrier 18. A ring gear 26 is splined to the output shaft 28.

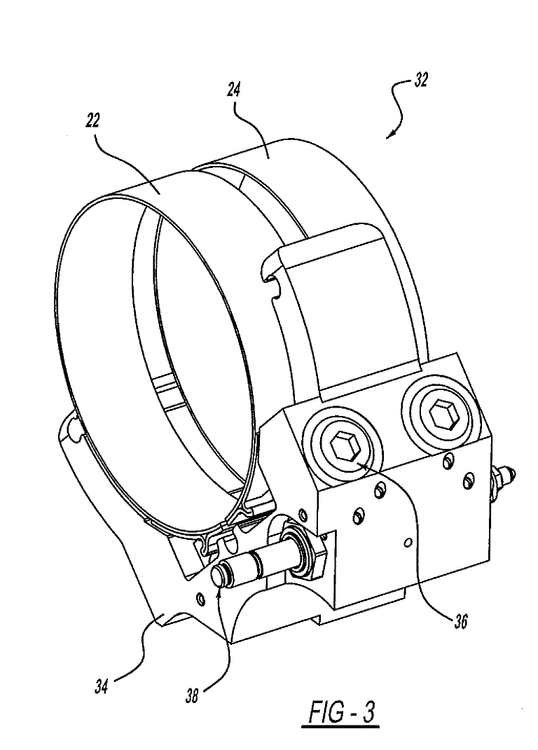

The band assembly 32 is illustrated in FIG. 3 and includes the front band 22 and rear band 24. A band manifold 34 supports the front and rear bands 22, 24 along with the piston assembly 36 and hydraulic valve 38, for activating the bands 22, 24 to engage the gear set 10.

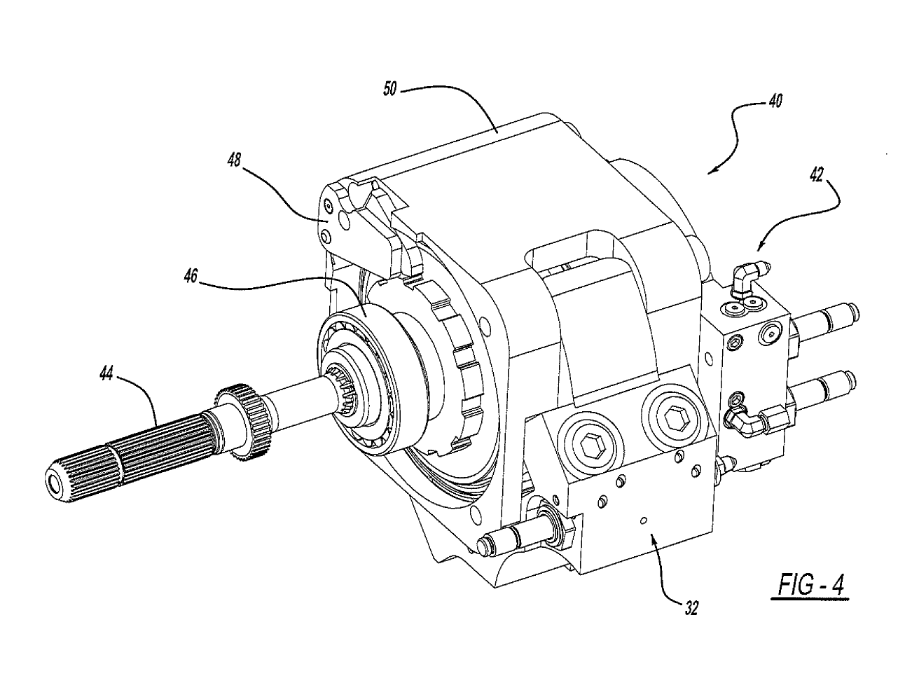

FIG. 4 illustrates the rear gear assembly 40 encased within the band assembly 32. The rear gear assembly 40 includes a rear clutch subassembly 42 provided at one end and a tail shaft assembly 44 provided at an opposite end. A roller bearing assembly 46 and parking pawl 48 are also there shown.

With reference to FIG. 2, the principle on which the traditional planetary gear set operates is based on driving one unit, holding one unit, and taking the output from the free unit, where the units are the sun gear 20, planet carrier 18 with planet gears 30 and the ring gear 26. Clutches 14, 16 and brake bands 22, 24 control the holding and driving units. General principles of planetary gear set 10 operation are: if the planet carrier 18 is used as the output to transmit power to the driving wheels of a vehicle for instance, the gear set 10 operates in reduction (slower speed, more torque); if the planet carrier 18 is the input, receiving power from an engine, the planetary gear set 10 operates in overdrive (more speed, less torque); if the planet carrier 18 is held by rear band 24, the gear set 10 operates in reverse; if any two units are locked together, the gear set 10 operates in direct drive; and if no units are locked together or held, the gear set 10 operates in neutral.

Traditionally, reverse gear engages the outer clutch 16 to drive the sun gear 20 and hold the planet carrier 18 with rear band 24. This results in a reduced ratio, and reversed rotation of the ring gear 26 relative to the input hub 12.

In a preferred method of the invention, both first gear and reverse transmit power when the outer clutch 16 engages the sun gear 20 and the planet carrier 18 is held with rear band 24. The bi-directional prime mover 11 rotates clockwise to drive reverse gear and reverses direction rotating counterclockwise to drive first gear. The gear ratio remains a reduction for both first and reverse, but the output direction can be either reverse or forward. While reverse gear is obtainable with any gear ratio when providing a bi-directional prime mover 11 to drive a planetary gear set 10, it is generally acceptable to travel in reverse at the lower speed provided by the reduction rotation. Second gear with a 1:1 direct drive engages both the inner clutch 14 and outer clutch 16. This locks the input hub 12 to the ring gear 26 and spins the entire gearset 10 in the same direction as the input. Overdrive engages the inner clutch 14 to drive the planet carrier 18 and arrests the sun gear 20 with rear band 24. The result is overdrive of the ring gear 26 in the same rotation direction as the input hub 12.

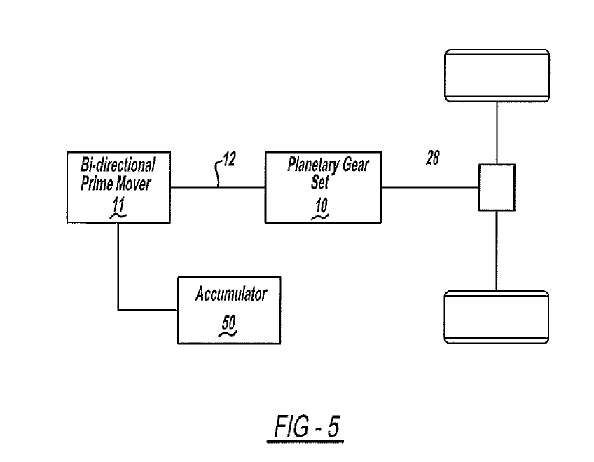

With reference to FIG. 5, a schematic of the present invention is there shown to more clearly illustrate the step of backdriving to store energy and includes a bi-directional primer mover 11 splined to the input hub 12. The input hub 12 in turn drives the planetary gear set 10 and rotates the output shaft 28. An accumulator 50 is provided to accumulate energy during backdrive. Because the planetary gear set 10 does not utilize sprags or one way clutches, such as a roller clutch provided with a traditional gear set, the output shaft 28 can spin and forcibly turn the input hub 12 to charge the accumulator 50 and regenerate energy to the system. Backdrive typically occurs when the vehicle is coasting and decelerating. Advantageously, the stored energy may be used to drive ancillary devices.

in accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A planetary gear set for use with a prime mover assembly comprising:
a bi-directional prime mover for providing power to a planetary gear set;
an input hub connected at one end to the prime mover and driving a planetary gear set in either direction; the planetary gear set consisting of:
one sun gear;
one set of planet gears mounted on a carrier for rotating about the sun gear;
two bands surrounding the planetary gear set; and
two clutch packs for engaging the planetary gear set;
an output shaft connected at an opposing end of the planetary gear set and receiving the power from the planetary gear set, wherein the output shaft is driven in one of first gear, reverse gear or backdriving.

2. The assembly of claim 1, wherein one of said two bands holds the planet carrier and one of said clutch packs engages the sun gear.

3. The assembly of claim 1, wherein the bi-directional prime mover is one of an electric motor or hydraulic motor.

4. The assembly of claim 1, wherein the planetary gear set provides three gear ratios including reverse.

5. The assembly of claim 2, wherein the planetary gear set provides one of either first gear or reverse to the output shaft.

6. The assembly of claim 5, wherein reverse to the output shaft provides either reverse gear or backdrive.

7. The assembly of claim 6, wherein the bi-directional prime mover is a hydraulic motor and further comprises an accumulator for accumulating power during backdrive.

8. A method for driving a planetary gear set by a bi-directional prime mover comprising the steps of:
providing a bi-directional prime mover for powering an input hub and driving a planetary gear set consisting of:
one set of planet gears mounted on a planet carrier and meshing with a sun gear;
two clutch packs for engaging the planetary gear set; and
two bands for holding the planetary gear set;
providing an output shaft for receiving the power from the bi-directional prime mover;
engaging a clutch pack to drive the sun gear;
holding the planet carrier with a band; and
the prime mover rotating the input hub in either direction to drive the output shaft direction in one of first gear, reverse gear or backdriving.

9. The method of claim 8, wherein the first gear comprises the step of:
the prime mover rotating the input hub in a clockwise direction and driving output shaft direction clockwise.

10. The method of claim 8, wherein reverse comprises the step of:
the prime mover rotating the input hub in a clockwise direction and driving the output shaft in a counterclockwise direction.

11. The method of claim 10, wherein backdriving comprise the step of:
the prime mover rotating the input hub in a clockwise direction and driving the output shaft in a counterclockwise direction.

12. The method of claim 8, wherein the prime mover is one of an electric motor or a hydraulic motor.

13. The method of claim 11, wherein the prime mover is a hydraulic motor and further comprising the steps of:
providing an accumulator for accumulating the power from the output shaft.

14. A method for driving a planetary gear set comprising the steps of:
providing a bi-directional prime mover for powering the planetary gear set;
providing an input hub connected to an end of a planetary gear set;
providing an output shaft connected to an opposing end of the planetary gear set;
the bi-directional prime mover rotating the input hub in either direction powering the planetary gear set; and
the planetary gear set driving an output shaft in either direction and providing three gear ratios and reverse.

15. The method of claim 14, the planetary gear set consisting of:
one set of planet gears mounted on a planet carrier and meshing with a sun gear;
two clutch packs for engaging the planetary gear set; and
two bands for holding the planetary gear set;
and further comprising the steps of;
rotating the input hub counterclockwise;
and the planetary gear set in combination with the output shaft providing reverse gear.

16. The method of claim 14, the planetary gear set consisting of:
one set of planet gears mounted on a planet carrier and meshing with a sun gear;
two clutch packs for engaging the planetary gear set; and
two bands for holding the planetary gear set;
and further comprising the steps of;
rotating the input hub clockwise;
and the planetary gear set in combination with the output shaft providing first gear.

17. The method of claim 14, the planetary gear set consisting of:
one set of planet gears mounted on a planet carrier and meshing with a sun gear; and further comprising the step of;
rotating the input hub counterclockwise;
and the planetary gear set in combination with the output shaft providing backdrive.

18. The method of claim 14, wherein the bi-directional prime mover is one of an electric motor or a hydraulic motor.

19. The method of claim 17, wherein the bi-directional prime mover is a hydraulic motor and further comprises an accumulator.

20. The method of claim 19, further comprising the step of:
the accumulator accumulating power when providing backdrive.
